(19) United States
(12) Patent Application Publication
(10) Pub. No.: US 2022/0027342 A1
(43) Pub. Date: Jan. 27, 2022

(54) METHODS FOR PROVIDING AND CHECKING DATA PROVENANCE

(71) Applicant: SONY GROUP CORPORATION, Tokyo (JP)

(72) Inventor: Niklas RYSTEDT, Lund (SE)

(21) Appl. No.: 17/311,487

(22) PCT Filed: Dec. 21, 2018
(86) PCT No.: PCT/SE2018/051359

§ 371 Date: Jun. 7, 2021

(51) Int. Cl. G06F 16/23; G06F 16/41; G06F 21/64

(52) U.S. Cl. CPC G06F 16/2365; G06F 21/64; G06F 16/41

(57) ABSTRACT

It is difficult to judge from a digital file only if it has been modified. By providing data provenance for a digital file when it is created and edited, the credibility of the file can be assessed. In a method for providing data provenance a digital media file comprising data and metadata is received (S40). Then a first storage ID, which identifies a first storage that is uniquely associated with the received file, is retrieved from the metadata (S41). An edited digital media file, which is an edited version of the received file is received (S42). A second storage ID which identifies a second storage that is uniquely associated with the edited file is created (S43) and stored in the metadata of the edited file (S44). Finally, the first storage ID is stored (S45) in the second storage to create a link to the received file from which the edited file was created.

### TECHNICAL FIELD

The invention generally relates to the field of data credibility, and more particularly to methods, apparatuses and products for providing and checking data provenance.

### BACKGROUND ART

Digital files are easy to modify and it is difficult to judge from a digital file only if it has been modified or if it is an original digital file. This is a problem for users of e.g. social media where digital media, such as images, video recordings and audio recordings, are widely spread and redistributed many times. People with malicious intents may illegitimately manipulate digital media to spread disinformation. Digital media may also be modified for legitimate reasons. An image may for instance be cropped to fit in a page without any change of relevant content or the audio properties of an audio recording may be changed to reduce background noise. However, even if a digital media file has been legitimately modified, a user may want to know in what way the digital media file has been altered, how many times it has been altered, when it has been altered, by whom and for what reason, i.e. to understand the history or provenance of the relevant data in the digital media file in order to assess to what degree the data can be relied on or trusted as representing what the data is supposed to represent.

US 2017/034162 discloses a system and process for securing digital media file content for persistence during distribution in a network. When the authenticity of a digital media file is to be verified in a network member node, a previously generated hash for the digital media file is retrieved from a trusted source. A current hash is generated for the digital media file. The hash from the trusted source and the current hash are compared. If the hashes match, the verification is approved, otherwise the verification is denied. This system and process do not provide any provenance information for the digital media files.

### SUMMARY

It is an objective of the invention to at least partly overcome one or more limitations of the prior art.

Another objective is to provide methods for assisting users to assess trustworthiness of digital media.

One or more of these objectives, as well as further objectives that may appear from the description below, are at least partly achieved by methods, data processing devices and computer program products according to the independent claims, embodiments thereof being defined by the dependent claims.

According to one aspect, the invention relates to a method for providing data provenance, the method being carried out by a data processing device, comprising the steps of:
receiving a digital media file comprising data and metadata;
retrieving, from the metadata of the received digital media file, a first storage ID which identifies a first storage that is uniquely associated with the received digital media file;
receiving an edited digital media file, which is an edited version of the received digital media file and which comprises data and metadata;
creating a second storage ID which identifies a second storage that is uniquely associated with the edited digital media file;
storing the second storage ID in the metadata of the edited digital media file; and
storing the first storage ID in the second storage identified by the second storage ID to provide data provenance for the edited digital media file.

According to another aspect, the invention relates to a method for checking data provenance, the method being carried out by a data processing device, comprising the steps of:
receiving a digital media file comprising data and metadata;
retrieving, from the metadata of the received digital media file, a first storage ID which identifies a first storage that is uniquely associated with the received digital media file,
checking, by means of the first storage ID, if there is at least one preceding version of the received digital media file.

According to yet another aspect, the invention relates to a method for providing data provenance, the method being carried out by a data processing device, comprising the steps of:
receiving a digital media file comprising data and metadata;
creating a storage ID which identifies a storage that is uniquely associated with the digital media file;
storing the storage ID in the metadata of the digital media file;
calculating a hash for the digital media file; and
uploading the hash to the storage identified by the storage ID.

By creating the storage ID and storing it in the metadata of the digital media file, the digital media file always carries a link to a storage where provenance and/or authentication information may be stored. By hashing the digital media file and storing the hash in the storage uniquely associated with digital media file, it can later on be verified that the digital media file including the storage ID has not been manipulated.

By storing a storage ID that identifies a storage that is uniquely associated with a previous version of a digital media file in the storage that is uniquely associated with the current version of the digital media file a link is created between storages that store information about different versions of the digital media file. This process may be repeated for every new version of a digital media file to form a chain of storage IDs of all versions of the digital media file. In this way a user may check if there is any previous version of a current digital media file and if so find any available information about any such previous version that has been stored in the associated storage. This will put the user in a better position to assess the credibility and trustworthiness of the data of the current digital media file.

Still other objectives, features, aspects and advantages of the present invention will appear from the following detailed description, from the attached claims as well as from the drawings.

### BRIEF DESCRIPTION OF DRAWINGS

Embodiments of the invention will now be described in more detail with reference to the accompanying schematic drawings.

FIG. 1A-1C are schematic views of systems in which digital media files are created, edited and viewed.

FIG. 2 is a schematic view of one embodiment of a data processing device.

FIG. 3 is a flow diagram for a method of providing data provenance.

FIG. 4 is a flow diagram for a method for providing provenance information when a digital media file is edited.

FIG. 5 is a flow diagram for a method for checking provenance and authenticity of a digital media file.

FIG. 6 is a flow diagram for a method of determining provenance information.

FIG. 7 is a schematic overview of a relation between a current digital media file and previous versions thereof.

FIG. 8 is a flow diagram for a method of determining a measure of similarity between two versions of a digital media file.

### DETAILED DESCRIPTION OF EXAMPLE EMBODIMENTS

The following disclosure relates to digital media files, and more particularly to methods for providing and checking data provenance of digital media files.

Data provenance (sometimes also called data lineage) as used in this disclosure refers to information regarding the history and origin of a digital media file. The history and the origin may be expressed in different ways and may include more or less detailed information.

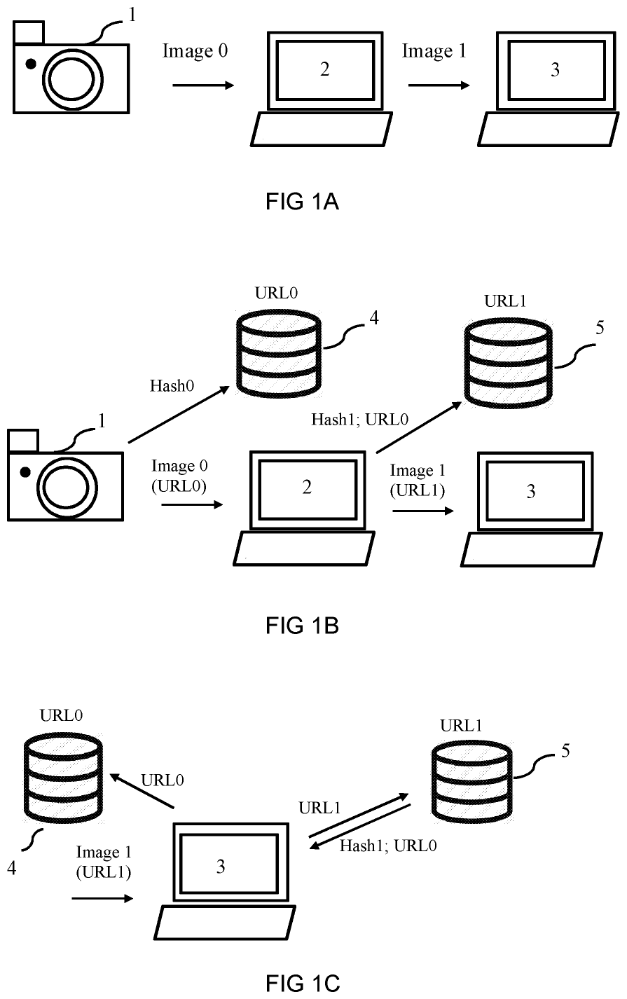

FIG. 1A schematically illustrates the need for providing data provenance for digital media files. A digital camera 1 captures an original image of a scene. As is standard in modern digital cameras, image data is stored in an image file (Image 0) and metadata relating to the image data is added to the image file. The image file (Image 0) is transferred from the digital camera 1 to a first computer 2. A user of the first computer 2 modifies the image data of the image file (Image 0) by means of a photo editing software run by the first computer 2. The modification may or may not affect the depiction of the scene. It results in an edited version of the original image captured by the digital camera 1, i.e. in an edited image, and thus in an edited image file (Image 1). The user of the first computer 2 uploads the edited image file to a network service. She may for instance post the image on social media. Eventually the edited image file (Image 1) is opened and the image is viewed by another user on a second computer 3. The problem of the user looking at the image on the second computer 3 is that she cannot know whether she looks at an original image or an edited image. Nor does she have any means for assessing how much she can trust the image to be authentic, i.e. to be an original image or an image that has been legitimately modified.

FIG. 1B schematically illustrates how authentication and provenance information can be provided to assist the user of the second computer in FIG. 1A. In the same way as in FIG. 1A, a digital camera 1 captures an original image of a scene. Image data is stored by the digital camera 1 in an image file (Image 0) and metadata relating to the image data is added by the digital camera 1. In the scenario of FIG. 1B, the digital camera 1 is configured to perform some further steps to create authentication and provenance information. It now also creates a storage ID (URL0) for the image file (Image 0), where ID stands for “Identification”. The storage ID (URL0) is stored by the camera 1 in the metadata of the image file. The digital camera 1 furthermore calculates a hash value (in the following also referred to simply as a “hash”) (Hash0) for the image file (Image 0) including the metadata. The hash (Hash0) is uploaded to a storage 4 specified by the storage ID (URL0). The image file (Image 0) is then transferred from the digital camera 1 to a first computer 2 which runs a photo editing software that is configured to provide authentication and provenance information. The user of the first computer 2 edits the image data of the original image file (Image 0), by means of the photo editing software, and thereby creates an edited version of the original image captured by the camera 1, i.e. in an edited image, and thus an edited image file (Image 1). The photo editing software also creates a storage ID (URL1) for the edited image file (Image 1) and adds it to the metadata of the edited image file. The photo editing software furthermore calculates a hash (Hash1) for the edited image file (Image 1) including the metadata. It also retrieves the storage ID (URL1) stored in the metadata of the original image file (Image 0). Finally, the hash value (Hash1) of the edited image file (Image1) and the storage ID (URL0) retrieved from the metadata of the original image file (Image 0) are uploaded to a storage 5 specified by the storage ID (URL1) created for the edited image file (image 1). In the same way as in the example of FIG. 1A, the user of the first computer 2 uploads the edited image file (Image 1) to a network service and eventually the edited image file (Image 1) is opened by a second user, who views the image on a second computer 3.

FIG. 1C schematically illustrates how the user who opens the image file (Image 1) on the second computer 3 can check authenticity and provenance information for the viewed image. In this scenario, the second computer 3 runs a viewer software that is configured to perform some steps for checking authenticity and provenance information. First the viewer software calculates a current hash for the opened image file (Image 1). Then it retrieves the storage ID (URL 1) stored in the metadata of the image file (Image 1) and uses the storage ID (URL1) to look up the information that was previously uploaded by the first computer 2 to the storage 5 specified by the retrieved storage ID (URL1). The stored information comprises the previously calculated hash (Hash1) for the image file (Image 1) and the storage ID (URL0) of the original image file (Image 0). The viewer software compares the previously calculated hash (Hash1) with the newly calculated hash, i.e. the current hash. If the hashes don't match, it can be concluded that the image file (Image1) has been modified after it was created and after the stored hash (Hash1) was calculated. It can be assumed that the modification is illegitimate. The user cannot trust the image to be authentic in this case. If the hashes match, it can be concluded that the image file (Image 1) is authentic. It has not been modified since it was created, i.e. after the stored hash (Hash1) was calculated, but the fact that the hashes match does not give the user any information about the history or origin of the image file and consequently the user does not know if the image is an original image or if it has been edited. However, since the stored information includes provenance information in the form of a storage ID, it can furthermore be established that there is at least one previous version (in the following also referred to as a preceding version) of the image file (Image 1). Thus the currently viewed image is not an original image, but an edited version. The viewer software may then check if the storage specified by the looked-up storage ID (URL0) stores a further storage ID for yet another previous version i.e. a previous version of the previous version of the opened image file. In the case illustrated in FIG. 1C, there is no further storage ID of a previous version stored in the storage 4 specified by the looked-up storage ID (URL0), and thus it can be concluded that there is only one previous version.

The example above relates to an image captured by a camera. However, the example is equally valid for other types of digital media, like audio captured by an audio recorder, video captured by a video recorder, or any other media that are encoded in machine-readable format and created by a corresponding digital electronic device. As is standard in these types of digital electronic devices, the captured media is stored in a digital media file as data. Information relating to the digital media is added as metadata to the digital media file. A current standard format for metadata of digital media files is EXIF (EXchangable Image File format). Another well-known format is XMP (eXtensible Metadata Platform) which is an ISO standard (ISO 16684) for metadata of digital files. The storage ID may be stored in a predetermined field in the metadata in a PreviousVersion field.

In the example above, the images are edited and viewed in computers. However, images and other digital media may also be edited and viewed or played in other digital electronic devices, like smartphones, PDAs, laptops, smartwatches, tablets and other computing devices that are configured to edit and reproduce (e.g. view or play) digital media files.

The storage IDs that are created for the digital media files in the example above identify specific storage locations where authenticity and provenance information for digital media files may be stored. A storage ID may be any suitable and unique identification of a digital storage. In some embodiments the storage ID is a URL (Uniform Resource Location) or a URI (Uniform Resource Identifier), i.e. the address of a WorldWideWeb page. In other embodiments the storage ID is a UNC (Uniform Naming Convention) referring to a storage location, typically on a Local Area Network.

Each created storage ID should be unique within the system that manages provenance information. Differently expressed, each digital media file should be uniquely associated with a storage that stores its provenance information, and two digital media files should never be associated with the same storage. The storage ID may be created in different ways to ensure that the digital media file is uniquely associated with the storage specified by the storage ID. Some embodiments uses an identifier of the hardware device on which the digital media file is created/edited or of the software for editing the digital media file for creating the storage ID. The identifier may be a serial number or a license number. To make it unique, the serial/license number may for instance be concatenated with a time stamp or a number from a counter that is increased after each creation of a storage ID. Then a hash value for the resulting string may be calculated and added to a predetermined network address to make the network address unique. An example for how the storage ID is composed would be www.camera-manufacturers-immutable-storage.com/<hash>. In some embodiments, a salt is added to the hash. This salt could be a random number or based on a known but secret hopping scheme derived from one or more of the properties that are unique to the digital media file, e.g. serial number, license number, timestamp, or counter.

In some embodiments, the storage is a network storage. It may be a distributed storage so that provenance information for different digital media files are stored on different hardware units. The storage may be an immutable storage, i.e. a storage in which the stored information cannot be erased or modified for a pre-determined length of time. Examples of immutable storages include storages based on blockchain technology.

In the example above, the storage specified by the storage ID stored in the metadata of a digital media file stores authentication and provenance information in the form of a hash value for the digital media file and a storage ID created for a preceding version of the digital media file. In some embodiments further provenance information may be stored for the digital media files. Examples of such further provenance information include:

A timestamp, which indicates when a digital media file was created or modified, or when provenance and/or authentication information for the digital media file is uploaded to the associated storage.

A manufacturer ID, which indicates a provider of hardware or software used for creating or modifying the digital media file.

A Client ID, which may comprise a serial number of a hardware or a license number of a software used for creating or modifying the digital media. As an alternative or supplement, a client ID may also be a client account, such as an ID associated with a hardware or software provider. A Client ID may have several uses: A user of the digital media file can make a better assessment of the media if he or she knows that it has been manipulated by a well-known company. A publisher can be transparent about how the media has been manipulated and thereby build trust. A viewer can use the client ID to search out what other manipulations the party associated with the client ID has carried out and use this information for assessing the authenticity of the media.

A locality sensitive hash value (also called a localized hash value): A locality sensitive hash function is a hash function that provides similar hash values for similar data. Locality sensitive hash values can consequently be used to search for similar data or media. It can also be used for providing a measure of similarity between two digital media files. In the system described in this application, it can be used to quantify the degree of manipulation between two links in the chain of different versions of a digital media file. This quantification can be used by a digital media reproducing software to suggest how trustworthy a digital media file is with regard to the manipulation it has undergone.

In some embodiments, the whole digital media file is uploaded to the storage identified by the storage ID created for the digital media file. In this way, a user may find not only an indication of the existence of one or more preceding versions of a current digital media file but the actual preceding version(s) by using the storage ID included in the metadata of the current digital media file to follow the links back to the storage(s) uniquely associated with the preceding version(s). Thus, a digital media file itself may constitute provenance information.

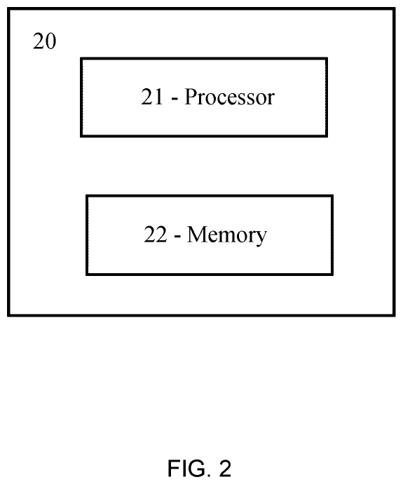

The steps of the methods for providing and checking data provenance, which will be described more in detail below, may be carried out by a data processing device comprising a processor to perform the methods. FIG. 2 is a schematic view of one embodiment of a data processing device 20. It comprises a processor 11 and memory 12. The processor may be a generic processor, e.g. a microprocessor, microcontroller, CPU, DSP (digital signal processor), GPU (graphics processing unit), etc., or a specialized processor, such as an ASIC (application specific integrated circuit) or an FPGA (field programmable gate array), or any combination thereof. The memory may include volatile and/or non-volatile memory such as read only memory (ROM), random access memory (RAM) or flash memory. It may store instructions which control the processor to perform the steps of the methods and data used for performing the methods.

The data processing device may be part of the digital electronic device that captures or processes the media. It may be used for other data processing as well. A module that implements the steps of the methods described in this disclosure may thus be one of many modules executed by the data processing device. The data processing device may be connected to other components of the digital electronic device and provide data to inputs and outputs of the digital electronic device.

The methods for providing and checking data provenance may also be embodied as a computer program product comprising instructions which, when the program is executed by the data processing device, cause the data processing device to carry out the steps of the methods.

The methods for providing and checking data provenance may also be embodied as a computer readable storage medium comprising instructions which when executed by a data processing device cause the data processing device to execute the steps of the methods.

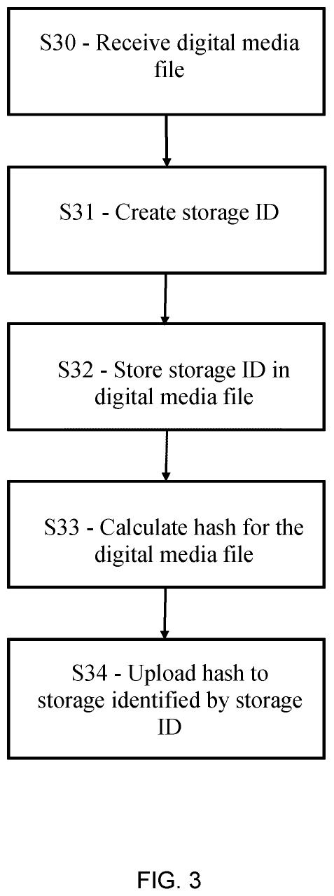

FIG. 3 is a flow diagram for a method for providing data provenance.

In a first step S30, a digital media file comprising data and metadata is received. Data in the digital media file may for instance be image data captured by an image sensor, video data captured by a video sensor or audio data captured by a microphone in a digital electronic device. The digital media file may be received as input to a module executed by a data processing device for carrying out the method for providing data provenance.

In a next step S31, a storage ID, which identifies a storage that is uniquely associated with the digital media file, is created. Examples of how the storage ID may be created are mentioned above.

In a following step S32, the storage ID created in step S31 is stored in the metadata of the digital media file.

In a subsequent step S33, a hash is calculated for the digital media file including the data as well as the metadata with the stored storage ID.

Finally, in step S34, the hash calculated in step S33 is uploaded to the storage identified with the storage ID created in step S31.

In this example, the received digital media file is an original file, i.e. a file that has not been edited and which consequently has no previous version. If the storage identified with the storage ID created for the digital media file has a field or a location for storing a storage ID for a previous version, this field may be left empty or be marked in another way to indicate that there is no previous version. A zero value or the storage ID of the current digital media file may for instance be uploaded to the storage in step S34 together with the hash. The method may thus include an optional step according to which the storage ID is uploaded to the storage identified by the storage ID. The method of FIG. 3 may also be used for edited digital media files to store information about where authentication information for the file may be found.

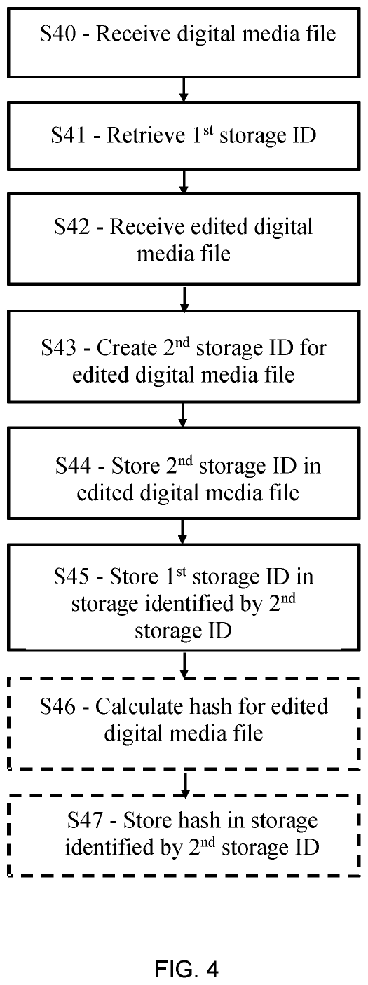

FIG. 4 is a flow diagram for a method for providing provenance information when a digital media file is edited.

In a first step S40, a digital media file comprising data and metadata is received. The digital media file may be an original digital media file or an edited digital media file that has already been modified one or more times. The metadata of the digital media file includes a first storage ID that was created when the received digital media file was created, i.e. originally created if the received digital media file is an original digital media file without any previous version or created by modification of a previous version of the digital media file if the digital media file is an edited digital media file. The first storage ID identifies a first storage that is uniquely associated with the received digital media file. The digital media file may be received as input to a module executed by a data processing device for carrying out the method for providing data provenance.

In a next step S41, the first storage ID is retrieved from the metadata of the received digital media file. The first storage ID is used to provide provenance information for a succeeding version of the received digital media file, i.e. for an edited versions of the received digital media file.

In a following step S42, an edited digital media file is received. The edited digital media file is an edited version of the received digital media file. It comprises data and metadata. It may be created by editing the data or the metadata or both the data and the metadata of the received digital media file. Editing of data may sometimes result in automatic editing of metadata. The editing of the digital media file may be carried out in the same data processing device as is used for executing the steps of this method or in a different device. The editing of the digital media file may furthermore be a step of the method. In such case the step S42 may be supplemented by a step of editing the digital media file to create an edited digital media file comprising data and metadata.

In a subsequent step S43, a second storage ID, which identifies a second storage that is uniquely associated with the edited digital media file, is created. Examples of how the storage ID may be created are mentioned above.

Then in step S44, the second storage ID created in step S43 is stored in the metadata of the edited digital media file.

Finally, in step S45, the first storage ID is stored in the second storage identified by the second storage ID in order to provide data provenance for the edited digital media file. Thereby a link is created to the received digital media file from which the edited digital media file was created. In some embodiments, the first storage ID is also stored in a field for previous version in the metadata of the edited digital media file.

In some embodiments, a hash is calculated in a further optional step S46 for the edited digital media file. The hash is calculated for both the data and the metadata, i.e. for the whole edited digital media file.

In a next optional step S47 the calculated hash for the edited digital media file is stored in the second storage identified by the second storage ID. It is thus stored in the same storage as the first storage ID. The calculated hash and the first storage ID may be stored as a tuple in the second storage.

In some embodiments, further provenance information is stored in the second storage. For that purpose, the method may include the further optional steps of calculating a locality sensitive hash for the data of the edited digital media file and storing the locality sensitive hash in the second storage. Also other provenance information may be created or retrieved and then stored in the second storage.

As is evident from above, the first and second storage IDs may be Uniform Resource Locators. The first and second storages may furthermore be immutable network storages. Also, the data of the received digital media file may comprise at least one of image data, video data and audio data. Finally, creating the second storage ID may comprise retrieving an identifier, such as a serial number or a license number, identifying a software or a hardware used for carrying out the method for providing data provenance.

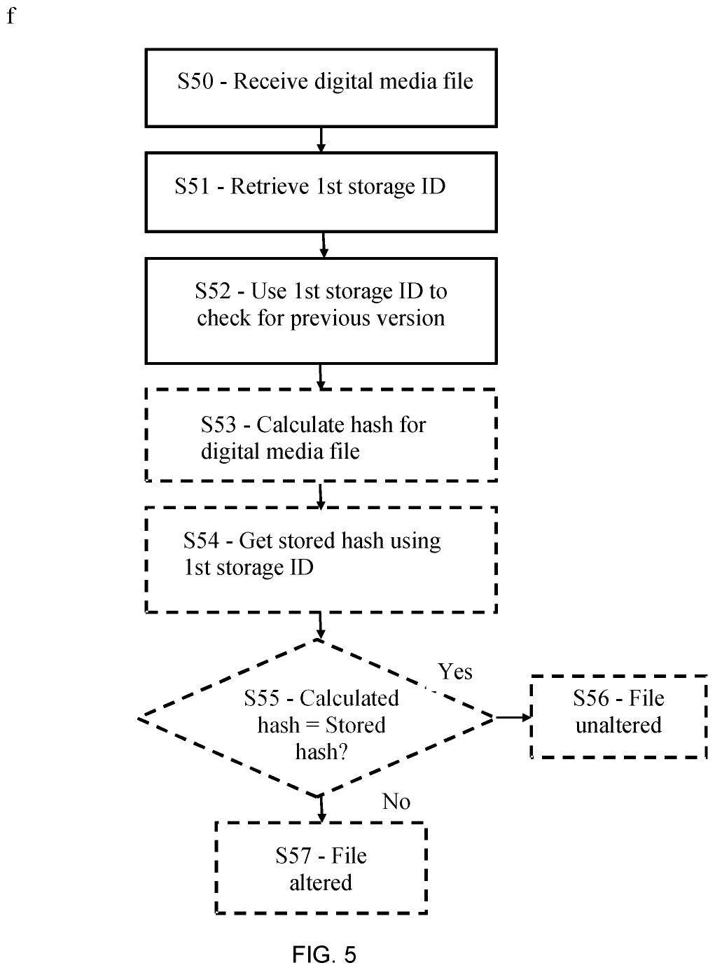

FIG. 5 is a flow diagram for a method for checking data provenance for a digital media file.

In a first step S50, a digital media file comprising data and metadata is received. The digital media file may be an original digital media file or an edited digital media file. The metadata of the digital media file includes a first storage ID that was created when the received digital media file was created, i.e. originally created if the received digital media file is an original digital media file without any previous version or created by modification of a previous version of the digital media file if the digital media file is an edited digital media file. The first storage ID identifies a first storage that is uniquely associated with the received digital media file. The digital media file may be received as input to a module executed by a data processing device for carrying out the method for providing data provenance.

In a next step S51, the first storage ID is retrieved from the metadata of the digital media file.

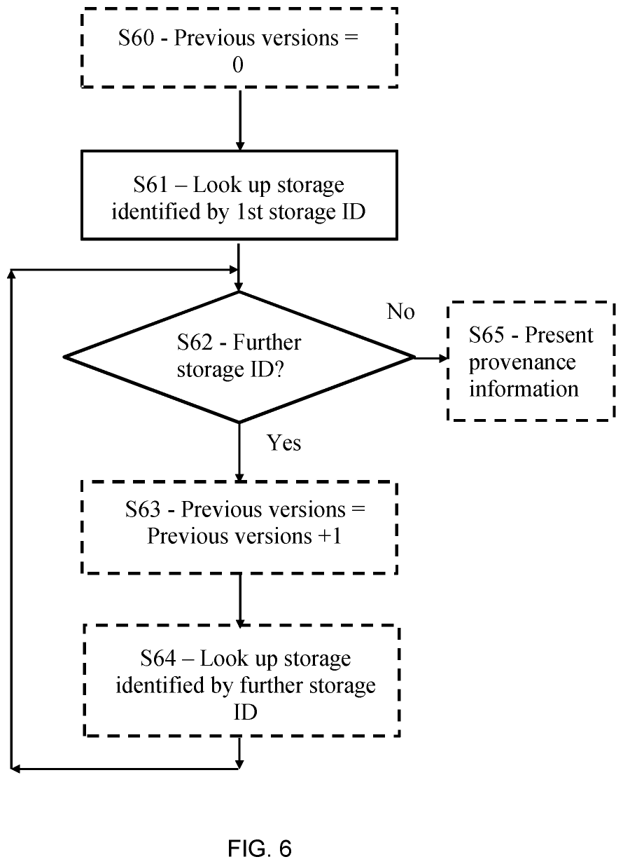

In a following step S52, the retrieved first storage ID is used to check if there is at least one previous version of the received digital media file, i.e. to check for provenance information. This step will be further explained and exemplified in connection with FIG. 6.

In some embodiments checking if there is at least one previous version of the received digital media file comprises checking if the first storage identified by the first storage ID stores a further storage ID which identifies a further storage that is uniquely associated with the previous version of the received digital media file; and establishing, if so is the case, that there is at least one preceding digital media file.

Furthermore, in some embodiments, it is checked if there is further preceding version(s) of the received digital media file by checking if the further storage identified by the further storage ID stores a next further storage ID which identifies a next further storage that is uniquely associated with a further preceding version of the received digital media file; and repeating, if so is the case, the checking until a final further storage is found that does not store any next further storage ID, wherein said final further storage that does not store a further storage ID is uniquely associated with a first version of the received digital media file.

Also, in some embodiments, the number of previous versions of the received digital file is counted, and an indication of the number of previous versions of the received digital media file is presented.

In an optional subsequent step S53, a current hash is calculated for the received digital media file.

In an optional following step S54, a previously calculated and stored hash for the received digital media file is retrieved from the first storage identified by the first storage ID.

In an optional next step S55, the current hash, which was calculated in step S53 for the received digital media file, is compared with the stored hash, which was retrieved in step S54 from the first storage. If the current hash matches the stored hash, it is concluded in step S56 that the received digital media file is authentic or unaltered, which means that it has not be modified since it was created and the hash was calculated and stored in the first storage. If the current hash does not match the stored hash, it is concluded in step S57 that the received digital media file has been altered or manipulated after the received digital media file was created and the hash was calculated and stored in the first storage. Consequently the received digital media file is not credible and should not be trusted. The manipulation of the digital media file may relate to data or metadata or both.

The methods of FIGS. 3-5 all include at least one step where a digital media file is received. The term receive should be broadly interpreted and include any way of making the digital media file available for the data processing device, including e.g. opening the digital media file, actively fetching it from a different module or device, passively receiving it from a different module or device or making it available as a result of a creating or editing the digital media file.

FIG. 6 is a flow diagram for a method for checking data provenance and more particularly for identifying an indication of the existence of one or more previous versions of a current digital media file and for counting the number of previous versions of the current digital media file. The steps of FIG. 6 may be carried out by a data processing device to implement step S52 and the current digital media file may be the digital media file received in step S50 from which a first storage ID was received in step S51.

In a first step S60 a counter which is named Previous versions is set to zero. Then in a following step S61 the first storage ID is used to look up provenance information in the first storage. In step S62, it is checked if the first storage stores a further storage ID, i.e. a storage ID created for a previous version of the current digital media file and stored in a PreviousVersion field in the first storage. If the first storage does not store a further storage ID, it can be concluded that there is no previous version of the current digital media file. This fact may be shown to a user as provenance information in step S65. If however the first storage does store a further storage ID, the counter named Previous version is increased with one in step S63 to indicate that there is at least one previous version of the current digital media file. In a next step S64, the further storage ID is used to look up provenance information in a further storage identified by the further storage ID. Then the flow returns to step S62 where it is checked whether the further storage stores a next further storage ID, i.e. a storage ID which was created for a further previous version of the current digital media file and which identifies a next further storage which is uniquely associated with the further previous version of the current digital media file. The loop is repeated until a final further storage is found that does not store any next further storage ID. When there is no further preceding version, the Previous version counter indicates the number of previous versions of the current digital media file. The number of previous versions is one kind of provenance information. In one embodiment the actual number or an indication thereof is presented in step S65 on a user interface of a digital electronic device.

In some embodiments, looking up provenance information may include looking up further provenance information in addition to the storage ID of the previous version. Such further provenance information may include a time stamp, a manufacturer ID, a client ID, a locality sensitive hash value, the complete previous version of the digital image file or any other stored provenance information.

In some embodiments, a copy of a previous version of the received digital file is retrieved by performing a search by means of the further storage ID that identifies the storage that is uniquely associated with the previous version. Since the storage ID is unique to the digital media file and stored in its metadata, it could be used to search for any public copy of the previous version in public databases.

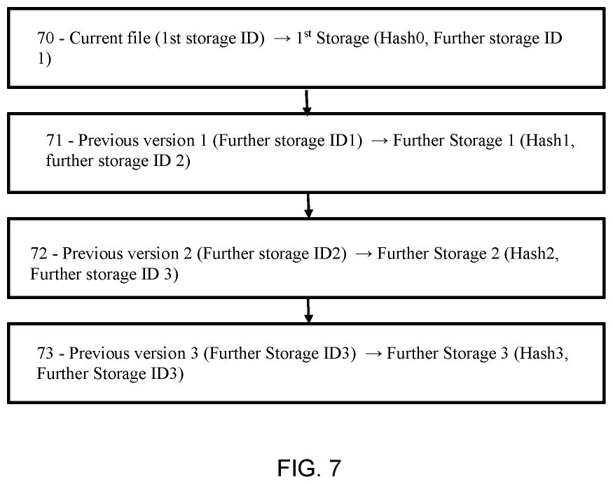

FIG. 7 is a schematic view that illustrates the relation between a current file and its previous versions in another way.

A first box 70 symbolizes a current file which is opened by a user. The file stores a first storage ID in its metadata. The first storage ID constitutes a link or address or pointer to a first storage, which stores a previously calculated hash (Hash0) for the current file and a Further storage ID1, which is a link to a storage (Further Storage 1) that is uniquely associated with the immediately preceding version of this current file.

A second box 71 symbolizes the immediately preceding version of the current file in box 70. It is called Previous version 1 and it stores the Further storage ID1 in its metadata. The Further storage ID1 constitutes a link to the Further Storage 1, which stores a previously calculated hash (Hash1) for the Previous version 1 and a Further storage ID2, which is a link to a storage (Further Storage 2) that is uniquely associated with the immediately preceding version of this Previous version 1.

A third box 72 symbolizes the immediately preceding version of the Previous version 1 in box 71. It is called Previous version 2 and it stores the Further storage ID2 in its metadata. The Further storage ID2 constitutes a link to the Further Storage 2, which stores a previously calculated hash (Hash2) for the Previous version 2 and a Further storage ID3, which is a link to a storage (Further Storage 3) that is uniquely associated with the immediately preceding version of this Previous version 2.

A third box 73 symbolizes the immediately preceding version of the Previous version 2 in box 72. It is called Previous version 3 and it stores the Further storage ID3 in its metadata. The Further storage ID3 constitutes a link to the Further Storage 3, which stores a previously calculated hash (Hash3) for the Previous version 2 and the Further Storage ID3, which is the same storage ID as is stored in the metadata of the Previous version 3. This indicates that there is no preceding version to this Previous version 3, which thus is the first or original version.

As can be seen the different versions of the file are linked together in a chain by the storage IDs. In this chain, the Previous version 2 is the immediately succeeding version of the Previous version 3, and the Previous version 1 is the immediately succeeding version of the Previous version 2 and the current file is the immediately succeeding version of Previous version 1.

From the above it can also be concluded that each previous version of a current digital media file is identified by a further storage ID, which identifies a further storage that is uniquely associated with the previous version of the received digital media file. The further storage ID is stored in the storage uniquely associated with the immediately succeeding version of the preceding version of the current digital media file.

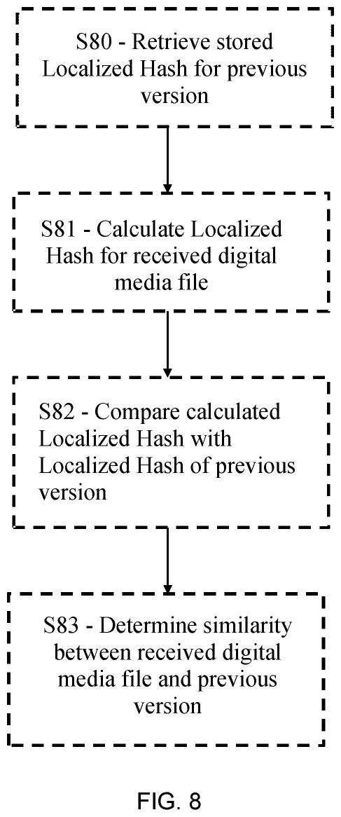

FIG. 8 is a flow diagram which schematically illustrates optional steps that can be used for determining a measure of similarity between two versions of a digital media file when one or more previous versions of a current digital media file have been identified. The steps of FIG. 8 may for instance be carried out after step S52 in FIG. 5 or after it has been established in step S64 of FIG. 6 that there is no further previous version.

In this embodiment it is assumed that a measure of similarity should be determined between a current digital media file which may be the digital media file received in step S50 and a previous version for which a locality sensitive hash (below Localized hash) has been previously calculated and stored as provenance information in a storage uniquely associated with the previous version.

In step S80, the localized hash for the previous version is retrieved from the further storage uniquely associated with the previous version. In step S81, a localized hash is calculated for the current digital media file. The calculation should use the same locality sensitive hash function that was used when calculating the localized hash of the previous version. Information about which locality sensitive hash function was used for calculating the stored localized hash may be stored together with the stored localized hash. It may also be a predetermined function.

In step S82, the localized hash calculated in step S81 is compared with the retrieved localized hash for the previous version. In step S83, a measure of similarity between the current file and the previous version is determined based on the size of the difference between the localized hashes. The measure of similarity may be shown as provenance information to the user.

In some embodiments, the localized hashes are calculated for the data only, i.e. not for the metadata.

The steps of the methods of FIGS. 3-6 and 8 may all be implemented by a client software run by a processor of a data processing device. However, some steps, like one or more of steps S60-S64 may also be implemented in a server software, to which the client software sends a web request including the first storage ID retrieved from the received digital media file and which returns the resulting provenance information, such as the number of previous versions and any other information found when following the further storage IDs in the chain of the previous versions.

In the flow diagrams of FIGS. 3-6 and 8, the method steps are presented in a certain order. However it is obvious to the skilled person that this order is not the only conceivable, but certain steps may be carried out in a different order or in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and the scope of the appended claims.

1. A method for providing data provenance, the method being carried out by a data processing device, comprising the steps of:
receiving a digital media file comprising data and metadata;
retrieving, from the metadata of the received digital media file, a first storage ID which identifies a first storage that is uniquely associated with the received digital media file;
receiving an edited digital media file, which is an edited version of the received digital media file and which comprises data and metadata;
creating a second storage ID which identifies a second storage that is uniquely associated with the edited digital media file;
storing the second storage ID in the metadata of the edited digital media file; and
storing the first storage ID in the second storage identified by the second storage ID to provide data provenance for the edited digital media file.

2. The method according to claim 1, further comprising:
calculating a hash for the edited digital media file, and
storing the hash for the edited digital media file in the second storage identified by the second storage ID.

3. The method according to claim 1, further comprising
calculating a locality sensitive hash for the data of the edited digital media file; and
storing the locality sensitive hash in the second storage.

4. The method according to claim 1, wherein the first and second storage IDs are Uniform Resource Locators.

5. The method according to claim 1, wherein creating a second storage ID comprises retrieving an identifier identifying a software or a hardware used for carrying out the method for providing data provenance.

6. The method according to claim 1, wherein the first and second storages are immutable network storages.

7. The method according to claim 1, wherein the data of the received digital media file comprises at least one of image data, video data and audio data.

8. A data processing device comprising a processor configured to perform the method of claim 1.

9. A non-transitory computer readable medium storing a computer program product comprising executable instructions which, when the program is executed by a data processing device, cause the data processing device to carry out the steps of the method of claim 1.

10. A method for checking data provenance, the method being carried out by a data processing device, comprising the steps of:
receiving a digital media file comprising data and metadata;
retrieving from the metadata of the received digital media file, a first storage ID which identifies a first storage that is uniquely associated with the received digital media file,
checking, by means of the first storage ID, if there is at least one preceding version of the received digital media file.

11. The method according to claim 10, wherein checking if there is at least one preceding version of the received digital media file comprises
checking if the first storage identified by the first storage ID stores a further storage ID which identifies a further storage that is uniquely associated with the preceding version of the received digital media file; and
establishing, if so is the case, that there is at least one preceding version of the received digital media file.

12. The method according to claim 11, further comprising checking if there is further preceding version(s) of the received digital media file by
checking if the further storage identified by the further storage ID stores a next further storage ID which identifies a next further storage that is uniquely associated with a further preceding version of the received digital media file; and
repeating, if so is the case, the checking until a final further storage is found that does not store any next further storage ID, wherein said final further storage is uniquely associated with a first version of the received digital media file.

13. The method of claim 12, further comprising:
counting the number of preceding versions of the received digital media file; and
presenting an indication of the number of preceding versions of the received digital media file.

14. The method of claim 10, further comprising:
calculating a current hash for the received digital media file;
retrieving, from the first storage, a stored hash for the received digital media file;
comparing the current hash for the received digital media file with the stored hash retrieved from the first storage; and
concluding that the received digital media file is authentic if the current hash matches the stored hash.

15. The method of claim 11, further comprising:
retrieving a stored locality sensitive hash for a previous version of the received digital media file in a further storage uniquely associated with the previous version;
calculating a locality sensitive hash for the received digital media file;
comparing the locality sensitive hash of the received digital media file with the retrieved locality sensitive hash for the previous version of the received digital media file; and
determining a measure of similarity between the received digital media file and the previous version of the received digital media file.

16. The method of claim 11, further comprising retrieving a copy of the preceding version of the received digital media file by performing a search by means of the further storage ID.

17. A data processing device comprising a processor configured to perform the method of claim 10.

18. A non-transitory computer readable medium storing a computer program product comprising executable instructions which, when the program is executed by a data processing device, cause the data processing device to carry out the steps of the method of claim 10.

19. A method for providing data provenance, the method being carried out by a data processing device, comprising the steps of:
receiving a digital media file comprising data and metadata;
creating a storage ID which identifies a storage that is uniquely associated with the digital media file;
storing the storage ID in the metadata of the digital media file;
calculating a hash for the digital media file; and
uploading the hash to the storage identified by the storage ID.

20. A data processing device comprising a processor configured to perform the method of claim 19.

21. (canceled)
